(19) United States
(12) Patent Application Publication
(10) Pub. No.: US 2008/0184227 A1
(43) Pub. Date: Jul. 31, 2008

(54) PROCESSOR CAPPING METHOD IN VIRTUAL MACHINE SYSTEM

(76) Inventors: Shuhei MATSUMOTO, Yokohama (JP); Hironori Inoue, Hadano (JP); Makiko Shinohara, Hadano (JP); Norimitsu Hayakawa, Inagi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/021,744

(22) Filed: Jan. 29, 2008

(30) Foreign Application Priority Data
Jan. 30, 2007 (JP) 2007-018668

(51) Int. Cl. G06F 9/455

(52) U.S. Cl. 718/1

(57) ABSTRACT

In a processor capping method in a virtual machine system, a complement virtual machine is created having a possessive processor time equal to the difference of subtraction of a possessive processor time given to the processor capping enabled virtual machine from a possessive processor time of the whole physical computer; a processor time by which each virtual machine utilizes the physical processor per unit time is determined; schedule priorities of each virtual machine and of the complement virtual machine are determined on the basis of their possessive processor times and the determined utilization processor time as well; and the schedule priority of the processor capping enabled virtual machine is compared with that of the complement virtual machine corresponding to the processor capping enabled computer to decide whether the schedule for the physical processor of the virtual processor the processor capping enabled virtual machine has is permissible or prohibitive.

### INCORPORATION BY REFERENCE

The present application claims priority from Japanese application JP2007-018668 filed on Jan. 30, 2007, the content of which is hereby incorporated by reference into this application.

### BACKGROUND OF THE INVENTION

The present invention relates to a virtual machine system and more particularly, to a method for causing a virtual machine monitor to control the schedule of a virtual machine and a virtual processor which the virtual machine has on the basis of a schedule priority.

As a standardized use of a physical computer comprised of a plurality of processors prevails and the technology develops, high multiplexing of processors has been advancing. In the future, the importance of a virtual machine system using a physical computer comprised of a plurality of processors and of a virtual machine system for configuring a virtual machine comprised of a plurality of virtual processors as well is expected to increase.

Some of virtual machine systems have the function to control the service rates for efficiently utilizing physical processors of the physical computer. The service rate is a value designated by a user every virtual machine, indicating an amount of physical processor service allotted to a virtual machine.

In case when all virtual processors of all virtual machines are allotted with physical processors so as not to stand idle and they are conditioned to constantly use up given times in terms of slice time, the designation of the service rate demands that a ratio between processor utilization rates should be equal to a ratio between the service rates among the virtual machines.

A virtual machine monitor (VMM) schedules the virtual processors of virtual machines for the physical processor in order that the aforementioned demand can be satisfied.

On the other hand, when there is a virtual machine not imposed with a load which uses up a processor service amount given pursuant to a designated service rate, the VMM in the virtual machine system gives a surplus processor service amount to a virtual machine being short of the processor service amount, thereby improving the processor utilization efficiency in the virtual machine system.

Through the above expedient, the processor utilization efficiency in the virtual machine system can be improved but from the standpoint of the individual virtual machines, discrepancy is present between the processor service amount given pursuant to the designated service rate and an actually required processor service amount. Even when taking one virtual machine, the processor service amount the virtual machine needs is not always constant but sometimes differs depending on time of day.

Among users of virtual machines, there are some users who want to use a virtual machine by making a contract of paying costs of necessary processor service amounts.

For these users, the processor service amounts given to the virtual machine must be limited to a contracted rate or less. As the function to limit the processor service amount, processor capping is available.

The service rate and processor capping are reported in Japanese Patent Publication No. 09-081401. The patent document describes a global processor capping method in which the virtual machine processor utilization rate is suppressed to a designated rate over a long real time (of the order of minute or hour).

### SUMMARY OF THE INVENTION

As far as all virtual machines are busy, a ratio of a processor utilization rate of a virtual machine for which processor capping is enabled is naturally limited to less than a ratio of a service rate through the service rate control (actually, to equality to the ratio) and an unbiased schedule offered by the service rate control can be observed.

On the other hand, if a virtual machine for which the processor capping is enabled stands busy and a virtual machine standing idle is active among other virtual machines, the processor capping is carried out explicitly to limit to less than a ratio of a service rate and to offer an unbiased schedule.

In a conventional virtual machine system, with a view to preventing a utilization processor time of a processor capping enabled virtual machine from exceeding a processor time being in the possession of the virtual machine, the schedule of the virtual machine for a physical processor is limited to thereby implement the processor capping.

The value of unit processor time is set as being sufficiently larger than a time slice and therefore, if the processor capping enabled virtual machine is conditioned to stand busy while the other of all virtual machines standing idle, the VMM continuously schedules virtual processors of the virtual machine for a physical processor, with the result that the utilization processor time of the virtual machine immediately reaches the possessive processor time of the virtual processor, thus performing limitation by the processor capping, and the schedule of the virtual machine for the physical computer is prevented until the utilization processor time is reset, eventually raising a problem that the schedule of the processor capping enabled virtual machine is extensively biased.

This makes the system response problematic and the processor capping cannot be used for programs, especially, a program which does not accept a long latency and does demand an unbiased schedule.

An object of the present invention is to draw up and carry out an unbiased schedule of a processor capping enabled virtual machine for a physical processor within a range in which the processor utilization rate of the virtual machine does not exceed a service rate designated by a user even when a virtual machine standing idle is active.

Another object of the present invention is to realize a processor capping method in which the processing time does not depend on either the number of virtual machines configured in the virtual machine system or the number of virtual processors each of the virtual machines has.

According to the present invention, a processor capping method in a virtual machine system in which a virtual machine monitor configures a plurality of virtual machines each having one or more virtual processors by time-sharing a physical computer having one or more physical processors, so that the schedule for the physical processor of each of the virtual machine and the virtual processor the virtual machine has is controlled on the basis of a schedule priority, said virtual machine monitor being operative to limit a processor utilization rate of each virtual machine to less than a designated service rate, comprising the steps of:

creating, for a virtual machine for which processor capping is enabled, a complement virtual machine having a possessive processor time equal to the difference of subtraction of a possessive processor time given to said processor capping enabled virtual machine from a processor time of the whole physical computer;

determining a processor time by which each virtual machine utilizes the physical processor per unit time; and

limiting the increasing rate of the utilization processor time of each virtual machine with increasing the time.

Further, according to the present invention, a processor capping method in a virtual machine system in which, for a processor capping enabled virtual machine, a complement virtual machine is created which has a possessive processor time defined by subtracting a possessive processor time given to the processor capping enabled virtual machine from a possessive processor time of the whole physical computer, a processor time by which each virtual machine utilizes a physical processor per unit time is determined, priorities of schedule of each virtual machine and of the complement virtual machine are determined on the basis of the possessive processor times of each virtual machine and of the complement virtual machine, and a schedule priority of the processor capping enabled virtual machine is compared with a schedule priority of the complement virtual machine corresponding to the processor capping enabled virtual machine to decide whether a schedule for the physical processor of the virtual processor the processor capping enabled virtual machine is permissible or prohibitive.

According to the present invention, when the processor capping enabled virtual machine is busy while another virtual machine standing idle is active, both the unbiased schedule and the processor capping can be realized.

Further, according to the present invention, the processor capping control uses only information about an objective virtual machine and information about the whole physical computer and therefore the processor capping can be implemented through a scheme in which the processing time does not depend on the number of virtual machines the virtual machine system has and the number of virtual processors the virtual machine has.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the configuration of an embodiment of a virtual machine system to which the present invention is applied.

FIG. 2 is a diagram showing the configuration of a VMM in an embodiment to which the invention is applied.

FIG. 3 is a conceptual diagram showing the relation of processor time between a physical computer and individual virtual machines.

FIG. 4 is a flowchart of a process for updating a virtual processor utilization time.

FIG. 5 is a flowchart of a process for updating a virtual machine utilization time.

FIG. 6 is a flowchart showing a process for selecting a virtual machine representing a schedule objective by the VMM when the processor capping is not applied.

FIG. 7 is a conceptual diagram showing the relation of a possessive processor time between physical computer, virtual machine and complement virtual machine and the relation of a utilization processor time between them.

FIG. 8 is a flowchart showing a process for selecting a virtual machine representing a schedule objective by the VMM when the processor capping method of the invention is applied.

### DETAILED DESCRIPTION OF THE EMBODIMENTS

An embodiment to which the present invention is applied will be detailed with reference to the accompanying drawings.

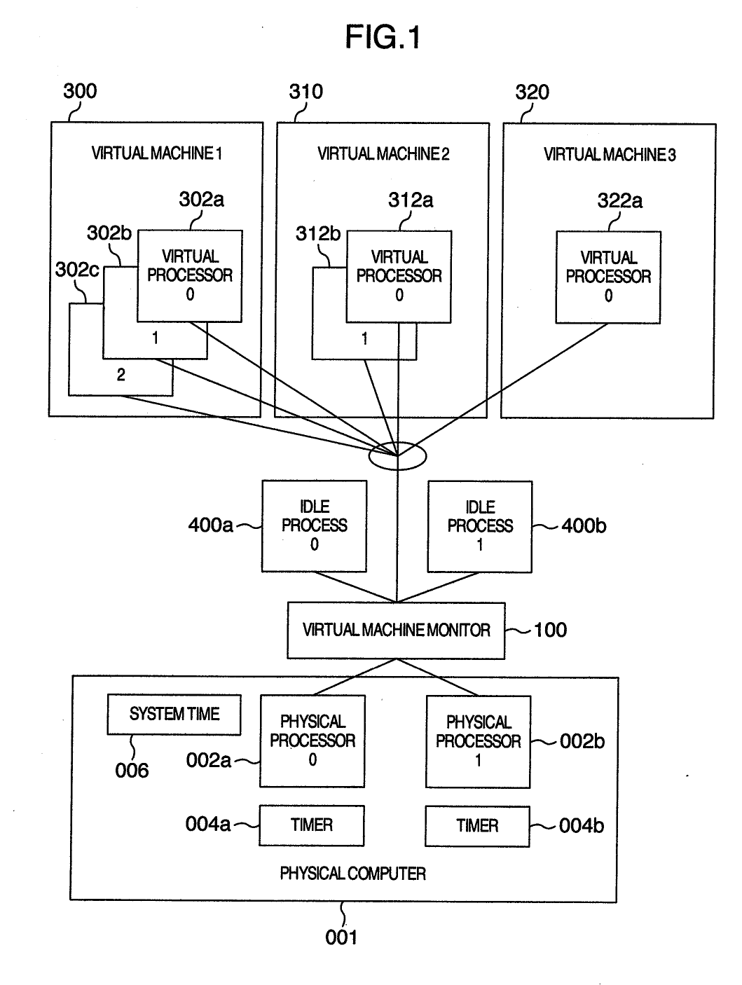

Referring to FIG. 1, a virtual machine system to which the present invention is applied is configured as diagrammatically outlined therein.

A physical computer 001 includes a physical processor 0 002a, a physical processor 1 002b, a system time 006 and timers 004a and 004b associated with the physical processors 0 002a and 1 002b, respectively.

In the present embodiment, the number of the physical processors is two but the present invention in no way limits the number of physical processors and can be applicable to a physical computer having one or more arbitrary number of physical processors.

The system time 006 is a time common to all of the physical processors and is consulted by a virtual machine monitor (VMM) 100 for the sake of measuring a physical processor time and warranting that the physical computer 001 alone or cooperative with the VMM 100 can always set up synchronization among all of the physical processors. In the present invention, a method of implementing the system time 006 does not matter. The timers 004a and 004b have each the function to generate an external interruption at a designated time and the VMM 100 uses them to time-division share the physical processors 0 002a and 1 002b according to time slices and to periodically control the utilization rate of the time-division sharing processor at intervals of time sections.

The VMM 100 time-division shares the physical processors 0 002a and 1 002b to set up a virtual machine 1 300 having a total of three virtual processors of virtual processor 0 302a, virtual processor 1 302b and virtual processor 2 302c, a virtual machine 2 310 having a total of two virtual processors of virtual processor 0 312a and virtual processor 1 312b and a virtual machine 3 320 having one virtual processor 0 322a.

Since in the present embodiment the processor capping method is considered not in a unit of virtual processor but in a unit of virtual machine, the method does not depend on the number of virtual processors of a virtual machine. Then, the processor capping method of this invention can be applicable to a virtual machine having one or more arbitrary number of virtual processors. Further, the number of virtual processors of a virtual machine can be larger than the number of physical processors.

The VMM 100 makes the correspondence between the physical processor 0 002a and an idle process 0 400a and the correspondence between the physical processor 1 002b and an idle process 1 400b and when no virtual processor to be scheduled for the physical processor is found, it executes the corresponding idle process on the physical processor until a virtual processor capable of being scheduled for the physical processor can be found.

The processor capping scheme in the virtual machine system of this invention is based on a theory of service rate. The service rate is a value the user designates virtual machine by virtual machine, indicating the size of physical processor resource allotted to a virtual machine. The service rate demands that when all virtual processors of all virtual machines are allotted with the physical processors so as not to stand idle and they are conditioned to constantly use up given time-slice times, a ratio between processor utilization rates of virtual machines should be equal to a ratio between service rates among all the virtual machines.

In the present embodiment, the mode of processor capping scheme in virtual machine system will be described which can be realized by adding the processor capping function to the virtual machine system having the function of service rate.

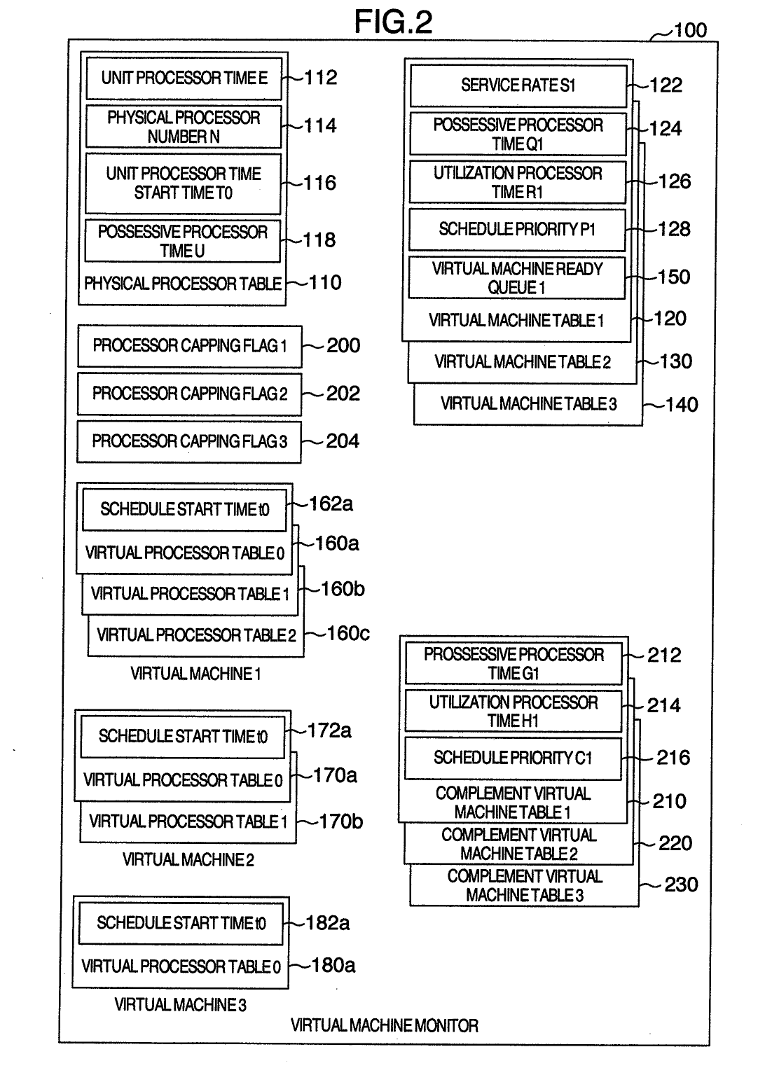

Referring to FIG. 2, the VMM 100 in the present embodiment is outlined in block diagram form.

Blocks the VMM 100 has are sorted into sections of physical processors, virtual machines and virtual processors belonging to the virtual machines.

The VMM 100 has a physical processor table 110 for the physical processors. The physical processor table 110 includes a unit processor time E 112, a physical processor number N 114, a start time of each unit processor time T0 116 and a possessive processor time U 118 the physical computer 001 has.

The VMM 100 also has, for the virtual machines, a virtual machine table 1 120, a virtual machine table 2 130 and a virtual machine table 3 140 in respect of the individual virtual machines.

Again, the VMM 100 also has processor capping flags 1 200, 2 202 and 3 204 for holding designation as to whether the processor capping is enabled or disabled in respect of each of the virtual machines. The monitor further has complement virtual machine tables 1 210, 2 220 and 3 230 which are used only when the virtual machine is enabled for processor capping.

The VMM 100 uses the virtual machine tables of all of the virtual machines in service rate control. In the processor capping control of the invention, the VMM 100 uses a virtual machine table of an objective processor capping enabled virtual machine and a complement virtual machine table associated with the virtual machine.

The virtual machine table 120 of virtual machine 1 300 includes an entry of service rate S1 122, entries of possessive processor time Q1 124 and utilization processor time R1 126 of the virtual machine, an entry of schedule priority P1 128 of the virtual machine 1 300 and an entry of virtual machine ready queue 1 150 for storing only an executable virtual processor. This holds true for the virtual machine table 2 130 of virtual machine 2 310 and the virtual machine table 3 140 of virtual machine 3 320.

The processor capping flag 1 200 of virtual machine 1 300 is used to decide whether the processor capping control is made to be enabled for the virtual machine. This holds true for the processor capping flag 2 202 of virtual machine 2 310 and the processor capping flag 3 204 of virtual machine 3 320.

If the processor capping is enabled for the virtual machine 1 300, a complement virtual machine table 1 210 corresponding to the concept of complement virtual machine is used.

The complement virtual machine table 1 210 has, like the virtual machine table 1 120 but excepting the service rate, entries of possessive processor time G1 212, utilization processor time H1 214 and schedule priority C1 216. Similarly, if the processor capping is enabled for the virtual machines 2 310 and 3 320, they use the complement computer tables 2 220 and 3 230, respectively. The complement virtual machine tables 2 220 and 3 230 are configured similarly to the complement virtual machine table 1 210. The complement virtual machine table will be described in greater detail in connection with a method for implementing the processor capping method of this invention.

Virtual processor tables 160a, 160b and 160c, 170a and 170b and 180a of the individual virtual processors include schedule start times t0 of corresponding virtual processors, respectively.

It will now be described how a demand imposed on the service rate designation can be met by using the information depicted in FIG. 2 in one of methods for realizing the service rate adopted in the present embodiment.

Firstly, a method of calculating information used by the VMM 100 for satisfying the demand tasking the service rate designation will be described.

A possessive processor time of the physical computer will be determined as follows.

The physical processors 002a and 002b of physical computer 001 are time-shared in a unit processor time E 112 and a possessive processor time U 118 the physical computer 001 has is determined by multiplying the unit processor time E 112 by a physical processor number N pursuant to equation (1):

U=E×N (1)

The possessive processor time U 118 of physical computer 001 indicates the size of physical processor resource the physical computer 001 has. The unit processor time E 112 has a suitable value which is sufficiently larger than the time slice. In one implementation mode, the unit processor time E 112 is set to one second.

A possessive processor time of each virtual machine is determined as will be described below.

The possessive processor time U 118 of physical computer 001 determined by equation (1) is divided at ratios among service rates of all the virtual machines to determine a possessive processor time Q1 124 of the virtual machine 1 300, a possessive processor time Q2 134 of the virtual machine 2 320 and a possessive processor time Q3 144 of the virtual machine 3 330.

The possessive processor times Q1 124, Q2 134 and Q3 144 of the individual virtual machines indicate the size of physical processor resource allotted to each of the virtual machines.

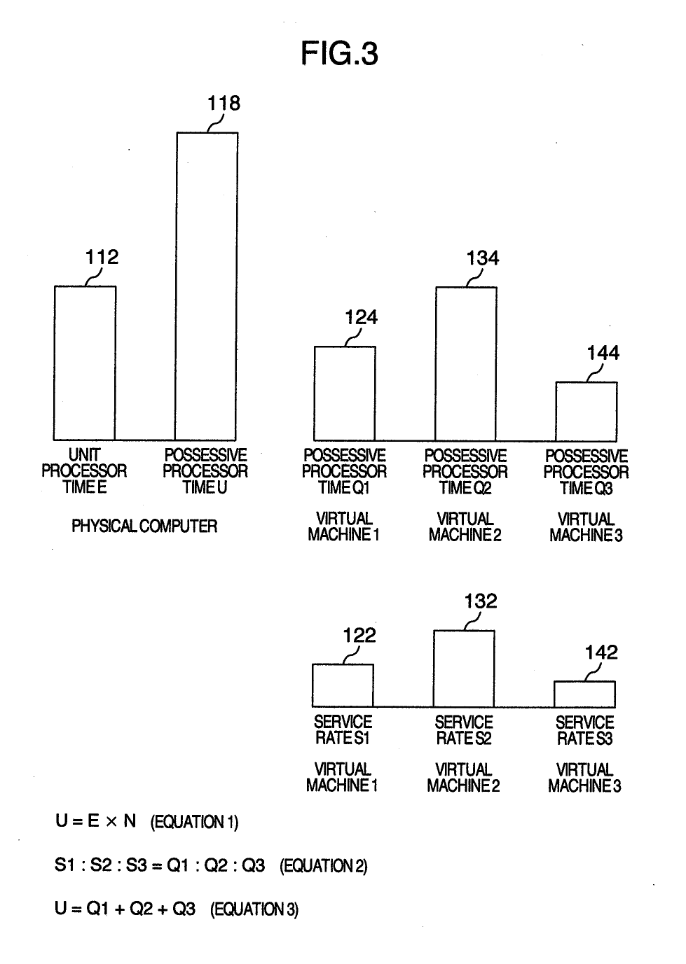

Diagrammatically imaged in FIG. 3 is a process in which the possessive processor time U 118 of physical computer 001 is divided in accordance with a ratio between the service rate S1 122 of virtual machine 1 300, the service rate S2 132 of virtual machine 2 310 and the service rate S3 142 of virtual machine 3 320 to determine the possessive processor times Q1 124, Q2 134 and Q3 144 of the individual virtual machines. Since the service rate is considered in a unit of virtual machine, the number of virtual processors the virtual machine has does not matter.

More particularly, the possessive processor time U 118 of physical computer 001 is divided at a ratio between the service rate S1 122 of virtual machine 1 300, the service rate S2 132 of virtual machine 2 310 and the service rate S3 142 of virtual machine 3 320 so that the individual virtual machines may be given the possessive processor times Q1 124, Q2 134 and Q3 144 pursuant to proportional expression (2) and equation (3) as follows:

S1:S2:S3=Q1:Q2:Q3 (2)

U=Q1+Q2+Q3 (3)

On the other hand, the utilization processor time R of the virtual machine is determined as will be described below. Each time the VMM 100 draws up the schedule of a virtual processor, the VMM 100 uses a schedule start time of the virtual processor held in its virtual processor table and a system time at the time of schedule end to thereby determine a utilization processor time of the virtual processor which in turn is added to the utilization processor time R in the virtual machine table of the virtual machine to which the virtual processor belongs.

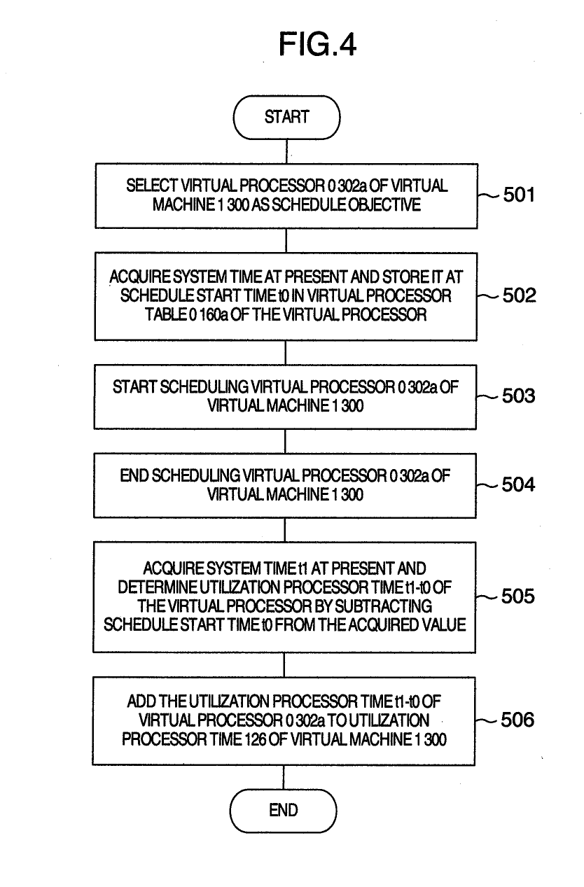

A flowchart of a process for updating the utilization processor time R of virtual processor is shown in FIG. 4. A description will be given by way of example of the virtual processor 0 302a of virtual machine 1 300 (501).

When a schedule of the virtual processor 0 302a starts (503), a system time at that time is held as a schedule start time t0 of virtual processor table 0 160a of the virtual processor (502). When the schedule of the virtual processor ends (504), the schedule start time t0 stored in the virtual processor table 0 160a is subtracted from a system time t1 at that time, thus determining a utilization processor time t1−t0 of the virtual processor (505).

The utilization processor time of the virtual processor can be determined every schedule of the virtual processor as the utilization processor time t1−t0 at that time whereas for the utilization processor time R of the virtual machine, addition is effected each time the virtual processor of the virtual machine is scheduled and resetting is repeated at intervals of the unit processor time E 112.

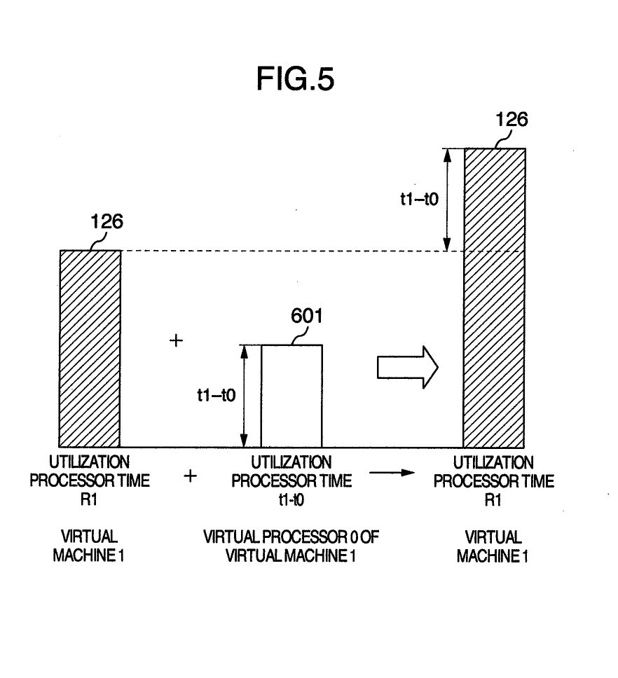

The process for updating the utilization processor time of the virtual machine is diagrammatically imaged in FIG. 5. The utilization processor time t1−t0 of the virtual processor determined as above is added to the utilization processor time R1 126 of the virtual machine 1 300 to which the virtual processor belongs (506).

Then, the utilization processor time R1 126 of virtual machine 1 300, the utilization processor time R2 of virtual machine 2 310 and the utilization processor time R3 of virtual machine 3 320 are all reset periodically at time intervals of the unit processor time E 112.

The VMM 100 determines a schedule priority of a virtual machine by using the possessive processor time and utilization processor time of the virtual machine as will be described below.

The VMM 100 determines, for example, a schedule priority P1 128 of the virtual machine 1 300 by a fractional number having the possessive processor time Q1 124 of virtual machine 1 300 as denominator and the utilization processor time R1 126 of virtual machine 1 300 as numerator, that is, pursuant to equation (4):

P1=R1/Q1 (4)

A schedule priority P2 of virtual machine 2 320 and that P3 of virtual machine 3 330 can be determined quite similarly.

The VMM 100 follows the schedule priority of virtual machine determined by equation (4) in order to keep scheduling the virtual machine 1 300, virtual machine 2 310 and virtual machine 3 320 for the physical processor 0 002a and physical processor 1 002b, thus satisfying the demand imposed on the service rate S1 122, service rate S2 132 and service rate S3 134.

The VMM 100 constantly derives a virtual processor of a virtual machine having the minimum schedule priority P of virtual machine among all virtual machines having schedulable virtual processors from a ready queue of the virtual machine and schedules it for the physical processor, so that it is possible to satisfy the demand imposed on service rate that when all virtual processors of all virtual machines are allotted with the physical processors so as not to stand idle and they are conditioned to constantly use up given time-slice times, the ratio between processor utilization rates should be equal to the ratio between the service rates among the virtual machines.

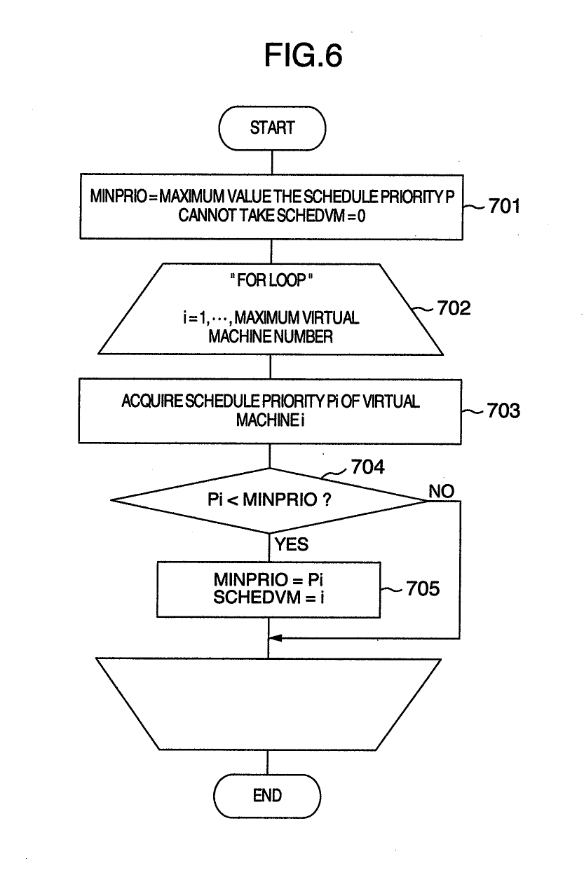

A flowchart of algorithm of a process for the VMM 100 to select a schedule objective virtual machine is shown in FIG. 6. The processor capping control is not included.

In the algorithm shown in the FIG. 6 flowchart, the VMM 100 uses, in addition to the schedule priority P of virtual machine, temporary variables including i used “for loop” and indicative of a virtual machine number, an MINPRIO for holding a minimum value of schedule priority P of virtual machine because the smaller the value of schedule priority P, the higher the priority becomes and a virtual machine number having a schedule priority of the value of MINPRIO, that is, a SCHEDVM for holding the schedule objective virtual machine number.

Firstly, the MINPRIO is initialized by a value for invalidating it, more specifically, by a value sufficiently large for the schedule priority P not to take and the SCHEDVM is initialized by a non-existing virtual machine number 0 (701).

Then, the “for loop” adapted to acquire a virtual machine number having the minimum schedule priority P is started. The “for loop” is executed by starting from i=1 and incrementally increasing i by 1 until the i becomes equal to the maximum virtual machine number (702).

A process inside the “for loop” will be described.

Firstly, a schedule priority Pi of a virtual machine i is acquired (703). Next, if the Pi has a value which is less than the temporary variable MINPRIO, the Pi value is substituted for the MINPRIO and i is substituted for the SCHEDVM (705).

In case the value of Pi exceeds the temporary variable MINPRIO, nothing needs to be done.

After going through the “for loop”, the schedule objective virtual machine number is stored in the temporary variable SCHEDVM.

If the value of SCHEDVM is non-zero, this means that a schedule objective computer is found. The VMM 100 takes a virtual processor from the ready queue of the virtual machine of the SCHEDVM number and schedules it for the physical processor. But, if the SCHEDVM value is zero, this means that a virtual machine to be scheduled is not found. In this event, the VMM 100 schedules an idle process for the physical processor.

The reason why the demand imposed on the service rate is satisfied through the FIG. 6 algorithm will be described.

The schedule priority Pi of virtual machine i increases as the execution of a virtual processor of the virtual machine i proceeds.

By keeping continuing the schedule of the virtual machine having the minimum schedule priority Pi, the VMM 100 constantly functions to make schedule priorities Pi of all virtual machines equal to one another.

The fact that the schedule priorities P1 128, P2 and P3 of the three virtual machines, that is, the virtual machines 1 300, 2 310 and 3 320 shown in FIG. 2, are equal to one another means that the following equation (5) is met:

P1=P2=P3->R1/Q1=R2/Q2=R3/Q3 (5)

By converting an equation on the right side, the following proportional expression (6) is introduced.

R1:R2:R3=Q1:Q2:Q3 (6)

On the other hand, the possessive times Q1 124, Q2 and Q3 of the virtual machines 1 300, 2 310 and 3 320 are set such that a ratio between the Q1, Q2 and Q3 equals a ratio between the service rates S1 122, S2 and S3. In other words, the following proportional expression (7) stands:

Q1:Q2:Q3=S1:S2:S3 (7)

From the two expressions (6) and (7),

R1:R2:R3=S1:S2:S3 (8)

is introduced.

Further, the utilization processor times R1 126, R2 and R3 of the virtual machines are reset periodically at time intervals of the unit processor time E 112 and therefore, at a certain time point, for example, physical time of the utilization processor time R1 126 of virtual machine 1 300 elapses equally to physical time of the utilization processor time R2 of virtual machine 2 310.

This means that where the start time of a time section or interval is Ts, its end time is Te and the utilization processor times of the virtual machines 1 300, 2 310 and 3 320 from Ts to Te are ΔR1, ΔR2 and ΔR3, respectively, the following expression (9) stands:

ΔR1/((Te−Ts)×N):ΔR2/((Te−Ts)×N):ΔR3/((Te−Ts)×N)=S1:S2:S3 (9)

where ΔR1/((Te−Ts)×N), ΔR2/((Te−Ts)×N) and ΔR3/((Te−Ts)×N) represent the processor utilization rates of the individual virtual machines 1 300, 2 310 and 3 320 over the time section Te−Ts, respectively.

Since Ts and Te can take arbitrary values, the demand imposed on the service rate can be met in an arbitrary time section through the algorithm shown in FIG. 6.

Next, the processor capping method in the virtual machine system of the present invention will be described.

As described in the foregoing, in the presence of an idle virtual machine, the ratio of the processor utilization rate of a busy virtual machine exceeds the ratio of the service rate and therefore, to make the busy virtual machine enabled for processor capping, a means for explicitly limiting the ratio of the processor utilization rate of the virtual machine to less than the ratio of the service rate needs to be applied.

The processor capping method in the virtual machine system of this invention is realized by adopting the theory of service rate.

What is warranted by the service rate under a specified condition is to make the ratio of the processor utilization rate of virtual machine equal to the ratio of service rate.

The process capping must meet the condition that the ratio of the processor utilization rate of a virtual machine is limited to less than the ratio of the service rate, this condition including making the ratio of the processor utilization rate of the virtual machine equal to the ratio of the service rate.

When the processor capping enabled virtual machine has a load which requires the ratio of the processor utilization rate in excess of the ratio of the service rate, it is desirable that the virtual machine can utilize the physical processor uniformly without bias at the ratio of the processor utilization rate equal to the ratio of the service rate.

The aforementioned condition requested by the service rate indicates a status that when the physical processors are allotted without causing all the virtual processors of all virtual machines to stand idle, the given time-slice time can always be used up.

If the above specified condition can be created when the processor capping needs to be tasked explicitly, a desirable processor capping can thereafter be implemented by using the above-described algorithm of the service rate.

On the other hand, when the load on the processor capping enabled virtual machine does not need so a large ratio of processor utilization rate as the ratio of the service rate, the ratio of the processor utilization rate of the virtual machine does not exceed the ratio of the service rate.

In this case, it is necessary for the processor capping method not to disturb the operation of service rate control. The processor capping method of the invention can satisfy this requirement as will be explained specifically in connection with embodiments.

How to implement the processor capping method in the virtual machine system according to the present embodiment will be described hereunder.

Firstly, it is assumed that an objective virtual machine for which the processor capping is enabled has a load which has a ratio of a processor utilization rate in excess of a ratio of service rate and the other virtual machines have each a load which does not require so a large ratios of processor utilization rates as the ratios of their service rates.

In this case, in order for the VMM to make the ratio of the processor utilization rate of the objective processor capping enabled virtual machine equal to the ratio of the service rates, the relation indicated by equation (5) must stand.

But, since the load on each of the other virtual machines is low, the relation shown by equation (5) does not stand in the service rate control among the virtual machines.

Conveniently, however, the existence of at least two virtual machines suffices to make the relation indicated by equation (5) stand.

Accordingly, in the event that for the processor capping enabled virtual machine, the relation indicated by equation (5) does not stand through the service rate control among the virtual machines, such a conceptual virtual machine is created in a pseudo-fashion by which the schedule algorithm of the VMM is so operated as to make the relation indicated by equation (5) always stand.

The conceptual virtual machine must satisfy a demand that among processor capping enabled virtual machines, the whole possessive processor time of the physical computer can be divided by a specified ratio and a demand that when a possessive processor time is given through the division of the possessive processor time of the physical computer, the processor capping enabled virtual machine can have a load capable of using up the possessive processor time.

The former demand can be met by making the sum of possessive processor time of the processor capping enabled virtual machine and possessive processor time of the conceptual virtual machine equal to the possessive processor time of the physical computer.

This can be realized by making a surplus processor time resulting from subtraction of the possessive processor time of the processor capping enabled virtual machine from the possessive processor time of the physical computer equal to the possessive processor time of the conceptual virtual machine.

The latter demand can be met if both the processor capping enabled virtual machine and the conceptual virtual machine stand busy, that is, an idle processor time does not exist as viewed from the algorithm of the schedule.

The nonexistence of the idle processor time as viewed from the schedule algorithm can be replaced by the fact that the sum of utilization processor times of the processor capping enabled virtual machine and of the conceptual virtual machine equals a value resulting from multiplying the elapse time from the start time of the unit processor time by the number of physical processors.

This can be realized by making the utilization processor time of the conceptual virtual machine equal to the difference of subtraction of the utilization processor time of the processor capping enabled virtual machine from the value as a result of multiplication of the lapse time from the start time of the unit processor time by the number of the physical processors.

The aforementioned methods for realizing the two demands are both based on an idea of using the rest of subtraction of the objective from the whole. The rest of subtraction of a set Q from a whole set U is called a complement set of Q and accordingly, the conceptual virtual machine realized by the rest information in a pseudo-fashion is defined as a complement virtual machine. The concept of complement virtual machine has no meaning for a virtual machine for which the processor capping is disabled.

In order for the complement virtual machine to fulfill the role of processor capping on the basis of the theory of service rate, the complement virtual machine is required to have a possessive processor time and a utilization processor time like the ordinary virtual machine. This requirement can be met specifically by using the complement virtual machine tables 210, 220 and 230 shown in FIG. 2.

The complement virtual machine table 1 210 for virtual machine 1 300 is taken for an example. The complement virtual machine table 1 210 has the possessive processor time G1 212, utilization processor time H1 214 and schedule priority C1 216. This holds true quite similarly for the virtual machines 2 310 and 3 320.

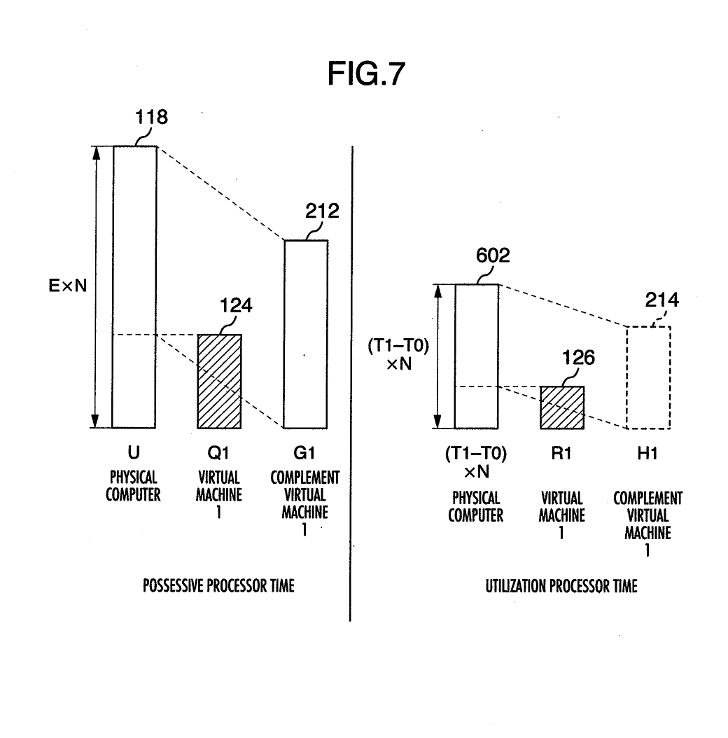

On the assumption that the virtual machine 1 300 is enabled for processor capping, the relation between possessive processor time and utilization processor time in the virtual machine 1 300 and the complement virtual machine 1 corresponding to the virtual machine 1 300 is illustrated in FIG. 7.

The possessive processor time G1 212 of the complement virtual machine 1 corresponding to the virtual machine 1 300 has a value determined by subtracting a possessive processor time Q1 124 of the virtual machine from the possessive processor time U 118 of the physical computer pursuant to equation (10):

G1=U−Q1 (10)

Next, the utilization processor time H1 214 of the complement virtual machine 1 is determined by subtracting a utilization processor time R1 126 of the corresponding virtual machine from the utilization processor time of the physical computer 001, that is, (T1−T0)×N obtained by multiplying a value (T1−T0) as a result of subtraction of the start time T0 116 of unit processor time from a system time T1 at that time by the physical processor number N 114, pursuant to equation (11) as follows:

H1=(T1−T0)×N−R1 (11)

As will be seen from equation (11), the utilization processor time H1 214 of complement virtual machine 1 means a total of processor times used by the virtual machine other than the corresponding virtual machine 1 300.

Then, the schedule priority C1 of complement virtual machine 1 is determined similarly to the schedule priority P1 of the corresponding virtual machine pursuant to equation (12):

C1=H1/G1 (12)

The possessive processor time G1 212, utilization processor time H1 214 and schedule priority C1 216 of the complement virtual machine 1 can all be determined from only the information about corresponding virtual machine 1 300 and the information about the whole physical computer 001. Calculation is simple and the calculation time does not depend on the number of virtual machines the virtual machine system has and the possessive processor times and utilization processor times the other virtual machines have.

When the processor capping enabled virtual machine 1 300 is busy and the remaining virtual machines 2 310 and 3 320 stand idle, the VMM 100 compares the schedule priority P1 128 of virtual machine 1 300 with the schedule priority C1 216 of corresponding complement virtual machine 1 and schedules the virtual machine taking a smaller value. Scheduling the virtual machine 1 300 signifies that a virtual processor the virtual machine 1 has is scheduled.

But scheduling the complement virtual machine 1 does not signify that a virtual processor of the complement virtual machine 1 is scheduled because the complement virtual machine 1 has the concept excluding any virtual processor.

More precisely, it is meant that the virtual processor of virtual machine 1 300 is not scheduled. If the VMM 100 cannot find another schedulable virtual machine on a physical processor, the idle processes 400a and 400b are scheduled until a schedulable virtual machine is found.

If a schedule priority Pi of a virtual machine i is below a schedule priority Ci of a complement virtual machine i, a certain virtual processor of the virtual machine i is scheduled but if not so, scheduling never proceeds. In the event that no virtual processor to be scheduled is found, the idle process is scheduled until a schedulable virtual processor can be found.

As far as the VMM 100 continues the above schedule, it constantly functions to make the schedule priority Pi of the virtual machine i equal to the schedule priority Ci of the complement virtual machine Ci as in equation (5).

The equality of the schedule priority Pi of virtual machine i to the schedule priority Ci of complement virtual machine i means that the following equation (13) is met.

Pi=Ci->Ri/Qi=Hi/Gi (13)

By converting an equation on the right side in equation (13), the following proportional expression (14) can be introduced.

Ri:Hi=Qi:Gi (14)

On the other hand, the following equation (15) is held for the possessive time Qi of virtual machine i and the possessive time Gi of complement virtual machine i:

Qi+Gi=Qi+(U−Qi)=U (15)

This signifies that Qi/U is a processor utilization rate tasked by processor capping.

As will be seen from the above, when the discussion proceeds as in the case of the aforementioned service rate and the VMM 100 continues scheduling a virtual machine taking a smaller one of values of the schedule priority Pi of virtual machine i and the schedule priority Ci of complement virtual machine i, the processor utilization rate of virtual machine i becomes equal to Qi/U, that is, a ratio of a service rate Si, so that a condition that the processor utilization rate tasked by the processor capping can be less than a ratio of the service rate Si can be met.

On the other hand, when the processor capping enabled virtual machine i stands idle, the schedule priority Pi of virtual machine i is smaller than the schedule priority Ci of the corresponding complement virtual machine i, that is, the following inequality (16) stands, with the result that limitation to the processor utilization efficiency according to the processor capping method of the present invention is not tasked.

Pi<Ci (16)

How inequality (16) stands will be introduced. When the processor capping enabled virtual machine i stands busy and a utilization processor time ranging from the start time T0 of unit processor time to a system time T at that time point is Ri, the Ri satisfies expression (13). If the utilization processor time in the same time section when the virtual machine i stands busy is Ri′, relational inequality (17) stands between Ri and Ri′.

Ri<Ri′ (17)

Further, where the schedule priorities of the virtual machine i and complement virtual machine i are Pi and Ci, respectively, when the utilization processor time is Ri′ and besides the schedule priorities of the virtual machine i and complement virtual machine i are Pi′ and Ci′, respectively, when the utilization processor time is Ri′, the following expressions (18) and (19) stand from expressions (10), (11), (12) and (17).

Ri′/Qi<Ri/Qi->Pi′<Pi (18)

((T1−T0)×N−Ri)/Gi<((T1−T0)×N−Ri′)/Gi->Ci<Ci′ (19)

From expressions (13), (18) and (19), inequality is held between Pi′ and Ci′ as follows:

Pi′<Ci′ (20)

As will be seen from the above, it is introduced that when the processor capping enabled virtual machine i stands idle, inequality (16) is met.

Next, how the processor capping method of the invention explained so far can coexist with the service rate control will be described.

In the virtual machine system configuration of FIG. 1, when the virtual machine 1 300, virtual machine 2 310 and virtual machine 3 320 all stand busy, a status will be considered in which the virtual machine 1 300 is made to be enabled for the processor capping and the virtual machines 2 310 and 3 320 are rendered disabled for the processor capping.

In that case, the following expression (21) stands through the service rate control.

P1=P2=P3->R1/Q1=R2/Q2=R3/Q3 (21)

At that time, equality of the schedule priority P1 128 of virtual machine 1 300 to the schedule priority C1 216 of the corresponding complement virtual machine 1 will be introduced. If this is evidenced, the processor capping method of this invention can be said as not preventing the normal operation of service rate control.

Firstly, the possessive processor time G1 212 of the complement virtual machine 1 corresponding to the virtual machine 1 300 equals the sum Q2+Q3 of the possessive processor times the virtual machines 2 310 and 3 320 have.

Namely, the following equation (22) stands:

G1=U−Q1=(Q1+Q2+Q3)−Q1=Q2+Q3 (22)

Then, when the above equation (22) stands, because of the idle time of the physical processor being zero, the sum of utilization processor times R1 126, R2 and R3 of the virtual machines 1 300, 2 310 and 3 320 equals the utilization processor time of physical computer 001, that is, (T1−T0)×N resulting from multiplying the difference (T1−T0) of subtraction of start time T0 116 of the unit processor time from the utilization processor time of physical computer 001, that is, a system time T1 at that time, by the number of physical processors N, thus demonstrating that the following equation (23) stands:

R1+R2+R3=(T1−T0)×N (23)

From this, the equality of the utilization processor time H1 214 of the complement virtual machine 1 corresponding to the virtual machine 1 300 to R2+R3 can be introduced as indicated by equation (24).

H1=(T1−T0)×N−R1=(R1+R2+R3)−R1=R2+R33 (24)

By using the possessive processor time G1 212 and utilization processor time H1 214 the complement virtual machine 1 has, the schedule priority C1 of complement virtual machine 1 can be determined pursuant to the following equation (25):

C1=H1/G1=(R2+R3)/(Q1+Q2) (25)

Equality of the schedule priority P1 126 of virtual machine 1 300 to the C1 216, that is, settlement of the following expression (26) can be introduced from the above equation (25):

P1=C1←→R1/Q1=(R2+R3)/(Q2+Q3) (26)

Since the service rate control and the processor capping method of the present invention can coexist, the algorithm of processor capping method of the invention can be added to the algorithm of the process for selection of a schedule objective virtual machine based on the FIG. 6 service rate control.

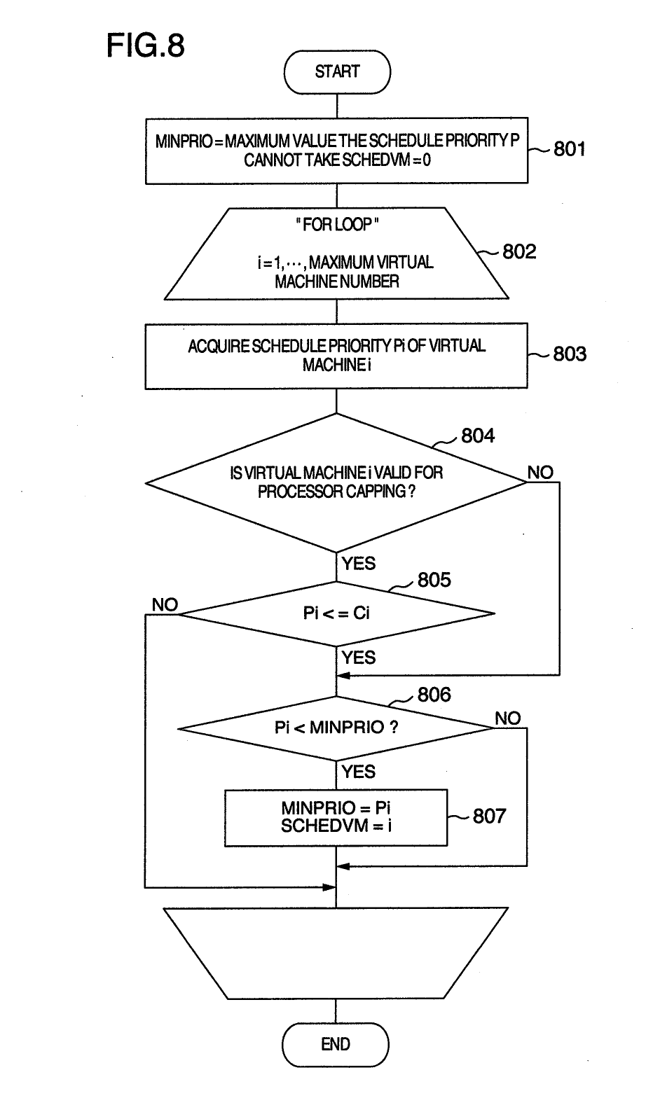

As shown in a flowchart of FIG. 8, the VMM 100 can execute an algorithm of a schedule objective virtual machine added with the processor capping method of the invention.

Added to the FIG. 6 flowchart are a step (804) of deciding whether the processor capping of a virtual machine is enabled and a step (805) of deciding whether for the processor capping enabled virtual machine, the schedule priority of the virtual machine is less than the schedule priority of a corresponding complement virtual machine.

In the algorithm shown in FIG. 8 flowchart, the VMM 100 uses, in addition to the schedule priority P of the virtual machine, temporary variables including used in the “for loop” to indicate a virtual machine number, an MINPRIO for holding a minimum value of the schedule priority P of virtual machine because the smaller the schedule priority P, the higher the priority becomes and a virtual machine number having a schedule priority of the value of MINPRIO, that is, an SCHEDVM for holding the schedule objective computer number.

Firstly, the MINPRIO is initialized with an invalid value, specifically, so a large value that the schedule priority P cannot take. Also, the SCHEDVM is initialized with the nonexistent virtual machine number 0 (801).

Then, the “for loop” adapted to acquire a virtual machine number whose schedule priority P is minimum is started. The “for loop” proceeds by starting with i=1 and incrementally increasing it by one until i equals the maximum virtual machine number (802).

A process inside the “for loop” will be explained.

Firstly, the schedule priority Pi of a virtual machine i is acquired (803).

The subsequent two steps 804 and 805 are added for the sake of realizing the processor capping method of the present invention.

Firstly, it is decided whether the virtual machine i is enabled for processor capping (804). If enabled, the program proceeds to the next step. If disabled, the program proceeds to step 806 in which it is decided whether the schedule priority of the virtual machine i is the minimum among all virtual machines.

With the virtual machine i being enabled for the processor capping, the schedule priority Pi of virtual machine i is compared with the schedule priority Ci of a corresponding complement virtual machine i (805). If Pi is larger than Ci, the processor capping is activated to determine a not-schedulable status, followed by skipping all the succeeding steps and proceeding to the next virtual machine i+1.

If Pi is smaller than Ci, deactivation of the processor capping is determined and the program proceeds to the next step 806.

Thereafter, if the value of Pi is determined as being less than the temporary variable MINPRRIO, the value of Pi is substituted for the MINPRIO and i is substituted for the SCHEDVM in step 807.

With the value of Pi being in excess of the temporary variable MINPRIO, nothing is done.

When the program having gone through the “for loop”, the schedule objective virtual machine number has been stored in the temporary variable SCHEDVM.

If the value of SCHEDVM is non-zero, it is meant thereby that a schedule objective virtual machine has been found. The VMM 100 takes a virtual processor from the ready queue of the virtual machine of the number in the SCHEDVM and schedules it for a physical processor.

But if the value of SCHEDVM is zero, it is meant thereby that no schedule objective virtual machine has been found. In such an event, the VMM 100 schedules an idle process for the physical processor.

When a virtual machine is tasked by the processor capping in which for example, a schedule of less than 25% processor utilization rate, that is, a schedule for 15 seconds per minute is permissible, the system response capability suffers from a problem that execution is carried out continuously for initial 15 seconds and then the processor capping is so limited as not to be executed absolutely for the remaining 45 seconds, but according to the processor capping method of the present invention, such a problem can be solved, thereby ensuring that the 25% processor utilization efficiency can be maintained during measurement in any time.

It should be further understood by those skilled in the art that although the foregoing description has been made on embodiments of the invention, the invention is not limited thereto and various changes and modifications may be made without departing from the spirit of the invention and the scope of the appended claims.

1. A processor capping method in a virtual machine system in which a virtual machine monitor configures a plurality of virtual machines each having one or more virtual processors by time-sharing a physical computer having one or more physical processors, so that the schedule for the physical processor of each of the virtual machine and the virtual processor the virtual machine has is controlled on the basis of a schedule priority, said virtual machine monitor being operative to limit a processor utilization rate of each virtual machine to less than a designated service rate, comprising the steps of:
creating, for a virtual machine for which processor capping is enabled, a complement virtual machine having a possessive processor time equal to the difference of subtraction of a possessive processor time given to said processor capping enabled virtual machine from a processor time of the whole physical computer;
determining a processor time by which each virtual machine utilizes the physical processor per unit time;
determining schedule priorities of each virtual machine and of said complement virtual machine on the basis of the possessive processor times of each virtual machine and of said complement virtual machine and said determined utilization processor time as well; and
comparing the schedule priority of said processor capping enabled virtual machine with that of said complement virtual machine corresponding to said processor capping enabled virtual machine to decide whether the schedule for said physical processor of the virtual processor said processor capping enabled virtual machine has is permissible or prohibitive.

2. A processor capping method in a virtual machine system according to claim 1, wherein when the schedule priority of said processor capping enabled virtual machine is equal to or higher than that of said complement virtual machine, the schedule priority of said processor capping enabled virtual machine is compared with a schedule priority of another virtual machine and if the schedule priority of said processor capping enabled virtual machine is the highest, the virtual processor said processor capping enabled virtual machine has is scheduled for said physical processor.

3. A processor capping method in a virtual machine system according to claim 1, wherein when the schedule priority of said processor capping enabled virtual machine is lower than that of said complement virtual machine, the virtual processor said processor capping enabled virtual machine has is not scheduled for said physical processor.

4. A processor capping method in a virtual machine system having a virtual machine monitor which controls, on a physical computer having one or more physical processors, the schedule for said physical processor of a virtual machine and of one or more virtual processors said virtual machine has and limits a processor utilization rate of the virtual machine to a designated service rate or less, where said physical computer has a possessive processor time U, said virtual machine has a possessive processor time Q, said physical computer has a physical processor number N and an elapse time T as well and said virtual machine has a utilization processor time R,
wherein for the possessive processor time Q of the virtual machine and the possessive processor time U of the physical computer, said virtual machine monitor gives these values to the virtual machine such that a fraction Q/U having a denominator indicative of the physical computer possessive processor time U and a numerator indicative of the virtual machine possessive processor time Q equals a processor utilization rate A designated to said virtual machine, that is, Q/U=A stands, the schedule priority of said virtual machine is determined to have a value indicated by a fraction R/Q having a denominator indicative of the possessive processor time Q of said virtual machine and a numerator indicative of the utilization processor time R thereof, the schedule priority of a corresponding complement virtual machine is determined to have a value indicated by a fraction (T×N−R)/(U−Q) having a denominator indicative of the difference U−Q as a result of subtraction of the possessive processor time Q of said virtual machine from the possessive processor time U of said physical computer and a numerator indicative of the difference T×N'1R as a result of subtraction of the utilization processor time R of said virtual machine from the utilization processor time T×N of said physical computer at that time as a result of multiplication of the physical computer lapse time T by the physical processor number N; and
wherein when the schedule priority value R/Q of said virtual machine is less than the schedule priority value (T×N−R)/(U−Q) of said complement virtual machine, that is,
R/Q≦(T×N−R)/(U−Q)
is satisfied, the virtual processor said virtual machine has is scheduled for said physical processor.

5. A processor capping method in a virtual machine system according to claim 4, wherein when each physical processor has an idle process and, at a time point, the virtual machines each having executable virtual processors are all enabled for processor capping under a condition that they are tasked by the processor capping without satisfying the aforementioned conditional expression R/Q≦(T×N−R)/(U−Q), a physical processor for which the above condition is detected is caused to continue execution of an idle process on said physical processor until at least one virtual machine satisfies the above conditional expression at the termination of lapse of a physical time.

6. A processor capping method in a virtual machine system in which a virtual machine monitor configures a plurality of virtual machines each having one or more virtual processors by time-sharing a physical computer having one or more physical processors, so that the schedule for the physical processor of each of the virtual machine and the virtual processor the virtual machine has is controlled on the basis of a schedule priority, said virtual machine monitor being operative to limit a processor utilization rate of each virtual machine to less than a designated service rate, comprising the steps of:
creating, for a virtual machine for which processor capping is enabled, a complement virtual machine having a possessive processor time equal to the difference of subtraction of a possessive processor time given to said processor capping enabled virtual machine from a processor time of the whole physical computer;
determining a processor time by which each virtual machine utilizes the physical processor per unit time; and
limiting the increasing rate of the utilization processor time of each virtual machine with increasing the time.
